(19) United States
(12) Patent Application Publication
(10) Pub. No.: US 2013/0244100 A1
(43) Pub. Date: Sep. 19, 2013

(54) IRON PHOSPHATES: NEGATIVE ELECTRODE MATERIALS FOR AQUEOUS RECHARGEABLE SODIUM ION ENERGY STORAGE DEVICES

(71) Applicant: IMRA AMERICA, INC., Ann Arbor, MI (US)

(72) Inventors: Bing TAN, Ann Arbor, MI (US); Zhendong HU, Ann Arbor, MI (US); Guanghui HE, Ann Arbor, MI (US); Yong CHE, Ann Arbor, MI (US)

(73) Assignee: IMRA AMERICA, INC., Ann Arbor, MI (US)

(21) Appl. No.: 13/827,768

(22) Filed: Mar. 14, 2013

Related U.S. Application Data
(60) Provisional application No. 61/611,288, filed on Mar. 15, 2012.

(51) Int. Cl. H01G 11/30; H01M 4/58; H01M 4/36

(52) U.S. Cl. CPC H01G 11/30; H01M 4/362; H01M 4/5825
USPC 429/199; 429/221; 429/188; 423/306; 423/307; 252/506; 252/521.2; 361/502

(57) ABSTRACT

Various embodiments of the present invention relate to electrode materials based on iron phosphates that can be used as the negative electrode materials for aqueous sodium ion batteries and electrochemical capacitors. At least one embodiment includes a negative electrode material for an aqueous sodium ion based energy storage device. The negative electrode material with a non-olivine crystal structure includes at least one phosphate selected from iron hydroxyl phosphate, Na₃Fe₃(PO₄)₄, Na₃Fe(PO₄)₂, iron phosphate hydrate, ammonium iron phosphate hydrate, carbon-coated or carbon-mixed sodium iron phosphate. At least one embodiment includes an energy storage device that includes such a negative electrode material.

### FIELD OF THE INVENTION

This invention relates to energy storage devices, and more particularly to electrode materials based on iron phosphates that can be used as the negative electrode materials for aqueous sodium ion batteries and capacitors.

### BACKGROUND

Aqueous batteries containing water as the solvent have been known for decades. Among them, lead-acid batteries have been extensively used in cars, electric bikes, and utility energy storage. In lead-acid batteries, lead and lead dioxide act as the active materials at the two electrode sides with concentrated H₂SO₄ as the electrolyte. These batteries are highly toxic and corrosive because of lead and the concentrated acid. On the other hand, nickel-based batteries such as nickel-metal hydride batteries and nickel-zinc batteries have relatively low toxicity. However, the cost of these batteries is much higher than the lead-acid batteries partially because of nickel, which was about $14.0/pound as compared to about $1.0/pound for lead in 2012 (http://www.metalprices.com/FreeSite/metals/nickelalloy/nickelalloy.asp). Therefore, there is a need for developing new, safe and environmentally benign batteries from low cost materials.

Recently, aqueous lithium-ion batteries have been studied by many researchers as a potentially safe system to compete with lead-acid batteries for certain applications. In an aqueous lithium-ion battery, both the negative electrode material and the positive electrode material can host lithium ions through lithium ion intercalation. An aqueous solution containing a lithium salt is used as the electrolyte. Compared to lead-acid batteries, these aqueous lithium ion batteries can be much safer through use of materials and salts with mild or low toxicity. For example, a battery based on LiTi₂(PO₄)₃ (negative electrode), LiMn₂O₄ (positive electrode), and Li₂SO₄ (electrolyte salt) is expected to be non-toxic and environmentally benign.

Regardless of the progress in aqueous lithium-ion batteries, the potential of these batteries might be limited by their relatively high cost because of the lithium salt in the electrolyte, which makes it difficult for them to compete with lead-acid batteries in cost. For example, the lithium price was about $28.0/pound in 2009 (http://www.metalprices.com/FreeSite/metals/li/li.asp). On contrary, the price for sodium was about $1.5/pound in 2009 (http://en.wikipedia.org/wiki/Sodium). Aqueous batteries based on sodium ions will be much cheaper than the corresponding lithium-ion batteries, which might be able to compete with lead-acid batteries in cost.

Compared to the aqueous lithium ion batteries, the research in aqueous sodium ion batteries has attracted little attention. Recently, Park et al. reported the application of NaTi₂(PO₄)₃ as the negative electrode material for aqueous sodium ion batteries (Park et al., “Electrochemical Properties of NaTi₂(PO₄)₃ Anode for Rechargeable Aqueous Sodium-Ion Batteries”, Journal of The Electrochemistry Society, 2011 (158), A1067). NaTi₂(PO₄)₃, however, is still relatively expensive. The cost of titanium is much higher than the cost of metals such as iron, zinc, copper, and manganese. Therefore, there is a need to develop a negative electrode material based on cheap and safe metals including, for example, iron, zinc, copper, or manganese.

### SUMMARY

An object of the present invention is to provide negative electrode materials based on low-cost and safe materials for aqueous sodium-ion energy storage devices.

At least one embodiment includes a negative electrode material, which includes an iron phosphate-based material as a negative electrode material for an aqueous sodium ion energy storage device.

At least one embodiment includes a negative electrode material having iron hydroxyl phosphate, iron phosphate hydrate, ammonium iron phosphate, or sodium iron phosphate with a non-olivine crystal structure.

At least one embodiment includes a negative electrode material with a non-olivine crystal structure for an aqueous sodium ion energy storage device, the negative electrode material having one carbon-coated and/or carbon-mixed sodium iron phosphate.

At least one embodiment includes a sodium-ion energy storage device having at least one iron phosphate-based material as the negative electrode material and an aqueous solution containing sodium ions as the electrolyte.

At least one embodiment includes an energy storage device. The device includes a negative electrode material having at least one iron hydroxyl phosphate, Na₃Fe₃(PO₄)₄, Na₃Fe(PO₄)₂, iron phosphate hydrate, ammonium iron phosphate hydrate, or carbon-coated/mixed sodium iron phosphate. A positive electrode material stores energy through faradic reactions or/and non-faradic reactions. The energy storage device further includes an aqueous electrolyte having sodium ions.

The above features and other features and advantages of the present invention will be presented in more detail in the following Drawings and Detailed Description.

### BRIEF DESCRIPTION OF THE DRAWINGS

FIG. 1 shows plots of: a). XRD patterns and b). cyclic voltammograms for Na₃Fe₂(PO₄)₃, carbon-coated Na₃Fe₂(PO₄)₃, and post-treated carbon-coated Na₃Fe₂(PO₄)₃.

FIG. 2 is a plot of XRD patterns for as-made Na₃Fe₂(PO₄)₃ and carbon black-mixed Na₃Fe₂(PO₄)₃.

FIG. 3 shows plots of: a). cyclic voltammograms for as-made Na₃Fe₂(PO₄)₃ and carbon black-mixed Na₃Fe₂(PO₄)₃ and b). constant current charge/discharge curves for carbon black-mixed Na₃Fe₂(PO₄)₃.

FIG. 4 shows plots of: a). an XRD pattern and b). constant current charge/discharge curves for Na₃Fe₃(PO₄)₄.

FIG. 5 shows plots of: a). an XRD pattern and b). constant current charge/discharge curves for Fe₅(PO₄)₄(OH)₃.2H₂O.

### DETAILED DESCRIPTION

Low-cost and safe energy storage devices are needed for a variety of applications. The research in this direction, however, has received little attention, in part because of lack of suitable electrode materials.

In 2010, Whitacre et al. (Whitacre et al., “Na₄Mn₉O₁₈ as a positive electrode material for an aqueous electrolyte sodium-ion energy storage device”, Electrochemistry Communications, 2010 (12), 463) reported the fabrication of a low-cost and safe energy storage device with Na₄Mn₉O₁₈ as the positive electrode material, activated carbon as the negative electrode material, and an aqueous solution containing sodium ions as the electrolyte. In this device, Na₄Mn₉O₁₈ stores energy through a sodium ion intercalation/de-intercalation process, while activated carbon stores energy through a non-faradic ion adsorption/desorption process.

Besides Na₄Mn₉O₁₈, other materials including NaMnO₂ (Qu et al., “A New Cheap Asymmetric Aqueous Supercapacitor: Activated carbon//NaMnO₂”, Journal of Power Sources, 2009 (194), 1222) and copper hexacyanoferrate (Wessells et al., “Copper Hexacyanoferrate Battery Electrodes with Long Cycle Life and High Power”, Nature Communications, 2011 (2), 1563) have also been reported as positive electrode materials for sodium ion batteries.

Compared to positive electrode materials, research regarding negative electrode materials has been limited. Recently, NaTiPO₄ has been reported as the sodium ion intercalation material in an aqueous electrolyte (Park et al., “Electrochemical Properties of NaTi₂(PO₄)₃ Anode for Rechargeable Aqueous Sodium-Ion Batteries”, 2011 (158), A1067). Titanium, however, is relatively expensive. It is preferable if a material based on other metals could be developed as the negative electrode material. Considering cost and safety, a metal including iron, zinc, copper, or manganese is particularly interesting as the electro-active component in the new electrode material. In particular, iron is highly attractive because of its non-toxicity, abundance, low cost, and proper redox potential of F²⁺/Fe³⁺. The sodium intercalation potential of Fe²⁺/Fe³⁺ is generally around 2.7 V vs. Li/Li⁺ in an organic electrolyte, which is about −0.34 V vs. SHE (i.e., standard hydrogen electrode). At pH 7, the theoretical hydrogen evolution potential of water is about −0.41 V vs. SHE (See Table 1 below). Therefore, the intercalation potential of Fe²⁺/Fe³⁺ could be within the stable range of water. Moreover, the redox potential of Fe²⁺/Fe³⁺ is well above the gas (hydrogen) evolution potential from the Pourbaix diagram of the iron-water system. It is, therefore, possible to utilize the redox pair of Fe²⁺/Fe³⁺ to store energy in an aqueous solution.

TABLE 1
Calculated H₂ and O₂ evolution potentials in water

| | H₂ evolution potential (V) | | | O₂ evolution potential (V) | | |
|---|---|---|---|---|---|---|
| | vs. | vs. | vs. | vs. | vs. | vs. |
| pH | SHE* | Ag/AgCl | Li/Li⁺ | SHE* | Ag/AgCl | Li/Li⁺ |
| 0 | 0 | −0.20 | 3.04 | 1.23 | 1.03 | 4.27 |
| 1 | −0.06 | −0.26 | 2.98 | 1.17 | 0.97 | 4.21 |
| 2 | −0.12 | −0.32 | 2.92 | 1.11 | 0.91 | 4.15 |
| 3 | −0.18 | −0.38 | 2.86 | 1.05 | 0.85 | 4.09 |
| 4 | −0.24 | −0.44 | 2.80 | 0.99 | 0.79 | 4.03 |
| 5 | −0.30 | −0.50 | 2.74 | 0.94 | 0.74 | 3.98 |
| 6 | −0.35 | −0.55 | 2.69 | 0.88 | 0.68 | 3.92 |
| 7 | −0.41 | −0.61 | 2.63 | 0.82 | 0.62 | 3.86 |
| 8 | −0.47 | −0.67 | 2.57 | 0.76 | 0.56 | 3.80 |
| 9 | −0.53 | −0.73 | 2.51 | 0.70 | 0.50 | 3.74 |
| 10 | −0.59 | −0.79 | 2.45 | 0.64 | 0.44 | 3.68 |
| 11 | −0.65 | −0.85 | 2.39 | 0.58 | 0.38 | 3.62 |
| 12 | −0.71 | −0.91 | 2.33 | 0.52 | 0.32 | 3.56 |
| 13 | −0.77 | −0.97 | 2.27 | 0.46 | 0.26 | 3.50 |
| 14 | −0.83 | −1.03 | 2.21 | 0.40 | 0.20 | 3.44 |

*SHE: standard hydrogen electrode

Iron phosphates including Li₃Fe₂(PO₄)₃, FePO₄, and Na₃Fe₃(PO₄)₄ have been studied as lithium ion intercalation materials in an organic electrolyte. In any or all embodiments, these materials as well as other iron phosphate-based materials can be used as the negative electrode materials for an aqueous sodium ion system.

As one example, sodium iron phosphates including Na₃Fe(PO₄)₂, Na₃Fe₂(PO₄)₃ and Na₃Fe₃(PO₄)₄ can be used as the negative electrode material to store energy through a sodium ion intercalation process. Three sodium iron phosphates including Na₃Fe(PO₄)₂, Na₃Fe₂(PO₄)₃, and Na₃Fe₃(PO₄)₄ are reported in the phase diagram of Na—Fe—PO₄ (Lajmi et al., “Reinvestigation of the binary diagram Na₃PO₄—FePO₄ and crystal structure of a new iron phosphate Na₃Fe₃(PO₄)₄”, Materials Research Bulletin, 2002 (37), 2407). Na₃Fe₂(PO₄)₃ generally has four crystal structures (α (monoclinic), β (intermediate phase), γ (triclinic poly type related to the NASCION family), and trigonal polymorph) (Belokoneva et al., “Synthesis and Crystal Structure of New Phosphate NaFe²⁺₄Fe³⁺₃(PO₄)₆”. Crystallography Reports. 2003 (48), 49). Na₃Fe₃(PO₄)₄ has a layered structure and has been studied by Trad et al. as sodium and lithium intercalation materials in an organic electrolyte (Trad et al., “Study of a Layered Iron (III) Phosphate Phase Na₃Fe₃(PO₄)₄ Used as Positive Electrode in Lithium Batteries”. Journal of the Electrochemical Society, 2010 (157). A947). Existence of other sodium iron phosphates including NaFeP₂O₇, Na₇Fe₄(P₂O₇)PO₄, NaFe₃P₃O₁₂, Na_{3.12}Fe_{2.44}(P₂O₇)₂, and Na₂Fe₃(PO₄)₃, NaFe₂Al(PO₄)₃ has also been reported in literature (Belokoneva et al., “Synthesis and Crystal Structure of New Phosphate NaFe²⁺₄Fe³⁺₃(PO₄)₆”, Crystallography Reports, 2003 (48). 49). However, none of these phosphates has been studied as a negative electrode material in aqueous electrolyte with sodium ions. In any or all embodiments, these sodium iron phosphates can be used as negative electrode materials in an aqueous electrolyte. On the other hand, sodium iron phosphate with an olivine crystal structure (i.e., NaFePO₄) has a high sodium intercalation/de-intercalation potential, which may be above 3.2 V vs. Li/Li⁺ or about 0.16 V vs. SHE. This sodium iron phosphate is preferably used as a positive electrode active material instead of a negative electrode active material because of its high sodium intercalation/de-intercalation potential.

Sodium iron phosphates can be prepared with various processes. For example, these phosphates can be prepared through a conventional solid-state process. Precursors of sodium salts, iron salts, and phosphate are mixed thoroughly and then the mixture is heated at a high temperature in air or oxygen for several hours. A temperature around 700° C. to 750° C. generally is good for the preparation of Na₃Fe₃(PO₄)₄. Higher or lower temperature may be necessary depending on the types of precursors. In another route, sodium iron phosphates such as Na₃Fe₃(PO₄)₄ may be prepared through a hydrothermal process. Trad et al. (Trad et al., “Study of a Layered Iron (III) Phosphate Phase Na₃Fe₃(PO₄)₄. Used as Positive Electrode in Lithium Batteries”. Journal of the Electrochemical Society. 2010 (157), A947) reported that Na₃Fe₃(PO₄)₄ can be prepared from a mixture of iron phosphate and sodium phosphate from a hydrothermal process.

Besides sodium iron phosphates, iron hydroxyl phosphates can also be used as the negative electrode materials. The iron hydroxyl phosphate can be expressed by the general formula Feₓ(PO₄)_{y}(OH)_{z}*nH₂O (x: 3 to 6, y: 2 to 4, z: 1 to 6, and n: ≧0). The iron hydroxyl phosphate can be selected from Fe_{1.39}PO₄(OH), Fe₃(PO₄)₂(OH)₂, Fe₃(PO₄)₂(OH)₂.4H₂O, Fe₅(PO₄)₄(OH)₃, Fe₅(PO₄)₄(OH)₃.2H₂O, Fe₆(PO₄)₄(OH)₅, Fe₆(PO₄)₄(OH)₅.6H₂O, Fe₅(PO₄)₃(OH)₅, Fe₅(PO₄)₃(OH)₅.2H₂O, Fe₄(PO₄)₃(OH)₃, and Fe₄(PO₄)₃(OH)₃.5H₂O. Wang et al. (Wang et al. “Stability, electrochemical behaviors and electronic structures of iron hydroxyl-phosphate”, Materials Chemistry and Physics, 2010 (123), 28) reported the electrochemical performance of Fe_{1.39}PO₄(OH) in an organic electrolyte. Its electrochemical performance in an aqueous electrolyte was not reported by the authors. In any or all embodiments, these iron hydroxyl phosphates can be used as the negative electrode materials in aqueous electrolyte.

Interestingly, iron phosphate hydrates and ammonium iron phosphate hydrates are also promising as negative electrode materials for aqueous electrolyte. Reale et al. (Reale et al., “Synthesis and Thermal Behavior of Crystalline Hydrated Iron (III) Phosphates of Interest as Positive Electrodes in Li Batteries”, Chemistry of Materials., 2003 (15), 5051) studied the electrochemical performance of FePO₄.2H₂O and NH₄(Fe₂(PO₄)₂OH.H₂O).H₂O in an organic electrolyte. These iron phosphates, particularly NH₄(Fe₂(PO₄)₂OH.H₂O).H₂O holds the potential to be used in an aqueous electrolyte.

To improve the structure stability, electronic conductivity, or/and electrochemical features of the phosphate during the charge/discharge cycling process, a sodium iron phosphate or iron hydroxyl phosphate may be doped or mixed with a certain amount of non-iron metal. These strategies may be similar to those that have been applied for a lithium iron phosphate, which has been studied as a positive electrode material for lithium ion batteries with organic electrolyte. For example. Ruan et al. (Ruan et al., “Effect of Doping Ions on Electrochemical Properties of LiFePO₄ Cathode”, Advanced Materials Research, 2011 (197-198). 1135) reported the improvement in cycling stability and high rate discharge capacity for LiFePO₄ after doping with Nb. In another example, Li₂TiFe(PO₄)₃ showed an extended potential range for lithium intercalation compared to the individual Li₃Fe₂(PO₄)₃ and LiTi₂(PO₄)₃, respectively (Patoux et al. “Crystal structure and lithium insertion properties of orthorhombic Li₂TiFe(PO₄)₃ and Li₂TiCr(PO₄)₃”, Solid State Sciences, 2004 (6), 1113). The non-iron metal that can be used for sodium iron phosphate or iron hydroxyl phosphate may be selected from magnesium, calcium, strontium, titanium, manganese, cobalt, nickel, copper, zinc, yttrium, titanium, zirconium, niobium, molybdenum, tungsten, aluminum, gallium, indium, tin, antimony, and bismuth. The molar ratio between the non-iron metal and iron can be in the range from 0 to 1.0, and more preferably in the range from 0.05 to 0.5 for non-reactive metal including aluminum.

The size of a potassium ion is larger than the size of a sodium ion. The partial or full replacement of sodium in sodium iron phosphate with potassium is expected to increase the crystal lattice size so that sodium ions may be more easily to be inserted or extracted.

It is possible that the phosphate anion in an iron phosphate may be partially replaced with silicate, borate, fluoride, and aluminate. The definition of “partially”, as used here, means that the molar ratio of the phosphate anion to the substituting anion is not less than 1. The partial replacement of phosphate with silicate/borate/fluoride/aluminate can reduce the molecular weight of a phosphate, which may result in an increase of the specific capacity. The replacement may also help to improve the cycling stability of an iron phosphate since the Fe—O—P bond tends to break in a basic aqueous solution.

Because a phosphate tends to have poor electronic conductivity, in some embodiments, an iron phosphate may need to be mixed or coated with a carbonaceous material. For example, the electrochemical activity of Na₃Fe₂(PO₄)₃ is negligible without the coating of carbon. The carbon coating may be achieved by either a chemical process or/and a physical process. For example, in a chemical process, a polymer or an organic compound such as sucrose can coat onto the surface of phosphate particles. Carbon-coated phosphates will be obtained after carbonizing the organic molecules into carbonaceous materials by decomposing them under an oxygen-free environment at high temperature. In a physical process, a carbon source such as carbon black or graphite can be mixed with a phosphate through high energy ball milling. The ball milling not only helps to crush large particles into small particles, but also improves the contacts between phosphate particles and carbon particles by physically pressing them together. The carbon can be any carbonaceous material with amorphous, semi-crystalline, and fully crystalline structure. The carbonaceous material may be selected from carbon black (acetylene black, Ketjen black, Super P), graphite, graphene, activated carbon, carbon fibers, carbon nanofibers, carbon nanotubes, carbon nanoparticles, crystalline carbon, semi-crystalline carbon, amorphous carbon, and their mixtures.

To improve the electrochemical reactivity of an iron phosphate, it is preferable for the particles to have smaller sizes so that there will be more particle/electrolyte interface and the ion diffusion length inside a particle is shorter. The particles are preferred to have nano-scaled size in the range from a few nanometers to hundreds of nanometers, and more preferably from 1 nm to 100 nm. Larger particles may still be able to be used for low rate applications.

In various implementations, the amount of iron phosphate in the electrode film may be in the range from 1 wt % to 100 wt %, and more preferably from 50 wt % to 90 wt %. A small amount of phosphate (1 wt % to 50 wt %) can be used with activated carbon to combine the advantages from both activated carbon (larger surface area) and iron phosphate (larger theoretical capacity).

To match with a non-toxic, abundant, low-cost iron phosphate-based negative electrode material, the positive electrode materials and the aqueous electrolyte would also be preferred to be non-toxic, abundant, and low-cost.

The positive electrode material may be any material that can store energy through either a physical non-faradic process or a chemical faradic process or both. The positive electrode material may be a porous carbonaceous material, which can store energy through an adsorption/desorption process.

In the case of a faradic process, the positive electrode electro-active material may be any material that can insert and extract sodium ions in an aqueous solution. It may be a mixture of at least two electro-active materials. In one example, the positive electro-active material comprises Na₄Mn₉O₁₈, which can insert/extract sodium ions at a positive potential of about 0.52 V vs. Ag/AgCl electrode (Whitacre et al., “Na₄Mn₉O₁₈ as a positive electrode material for an aqueous electrolyte sodium-ion energy storage device”, Electrochemistry Communications, 2010 (12), 463). The positive electrode material may be doped with at least one metal and/or coated with a carbonaceous material to improve its electrochemical performance.

In one example, the positive electrode material comprises a material that stores energy through redox reactions. For example, the positive electrode material may comprise a pseudo capacitive material, into or from which insert/extract H⁺ ions at the electrode/electrolyte interface. In another example. Ni(OH)₂ or MnO₂ may store energy by storing/releasing ions in an alkaline solution.

The positive electrode material can be a polymer that experiences faradic reactions during a charge/discharge process.

The positive electrode material can be a catalyst that can reduce oxygen and oxidize water as an air catalyst.

To make an electrode, an electric conductive agent and a polymer binder generally are needed to ensure the electric contacts among electro-active particles. The electric conductive agent may be selected from a carbonaceous material comprising carbon black (acetylene black, Ketjin black, Super P), carbon nanoparticles, carbon nanotubes, graphene, and graphite. The binder is to bind electro-active and conductive agent particles together and to bind the electrode film to the current collector, so that a good electric conductivity among the particles and between the electrode film and the current collector can be maintained for the electrode. The binder can be any compound that does not dissolve in water and can glue the particles together. The binder can be a fluorocarbon polymer comprising polytetrafluoroethylene (PTFE), poly(vinylidene fluoride) (PVDF), Nafion, fluorocarbon rubbers, and polyamide resin.

For the electrolyte, its pH value may be in the range from about 1 to about 13, and more preferably in the range from 2 to 7. A mild pH value is preferred because of the consideration of safety and the stability of the electrode materials. Iron phosphates may experience different working mechanisms depending on the pH values of the electrolyte. For example, Fe₅(PO₄)₄(OH)₃.2H₂O decomposes in a neutral or basic solution besides interacting with sodium ions during the cycling process. The phosphate seems to be more stable in a mild acidic solution.

A variety of alkaline metal salts can be used to provide the alkaline metal ions for the electrolyte. Sodium salts are the preferred choice for the electrolyte because they are cheaper than the corresponding lithium or potassium salts. Based on the operational principle, however, both lithium salts and potassium salts can be used in the electrolyte to provide lithium or potassium ions for an aqueous lithium ion or potassium ion energy storage device. In this case, iron phosphates, iron hydroxyl phosphates, lithium iron phosphates, and potassium iron phosphates may be used as the negative electrode materials.

A current collector generally is needed to deliver or remove electrons from the electrochemically-active layer. Two basic requirements for the current collector are good electronic conductivity and good stability during cycling in the targeted electrolyte. The current collector can be as a foil, sheet, mesh, expanded metal, or foam. The conductive substance can be selected from stainless steel, aluminum, nickel, titanium, copper, glassy carbon, graphite, conductive polymer, and their alloys or mixtures.

In an energy storage device, a separator generally is needed to electronically separate the negative electrode from the positive electrode while permitting ions to transport between the two electrodes. A good separator needs to be hydrophilic, porous, and electronic insulating. A variety of materials can be used to make the separator comprising nylon fiber, cotton fiber, cellulose fiber, polyester fiber, glass fiber, polyethylene (PE), polypropylene (PP), poly(tetrafluoroethylene) (PTFE), poly (vinyl chloride) (PVC), rubber, asbestos, and wood.

Some additional features, properties, and advantages of the present sodium ion energy storage devices are further disclosed in the following examples.

### EXAMPLES

### Example 1

### Preparation, Characterization, and Electrochemical Performance Evaluation of Carbon-Coated Na₃Fe₂(PO₄)₃

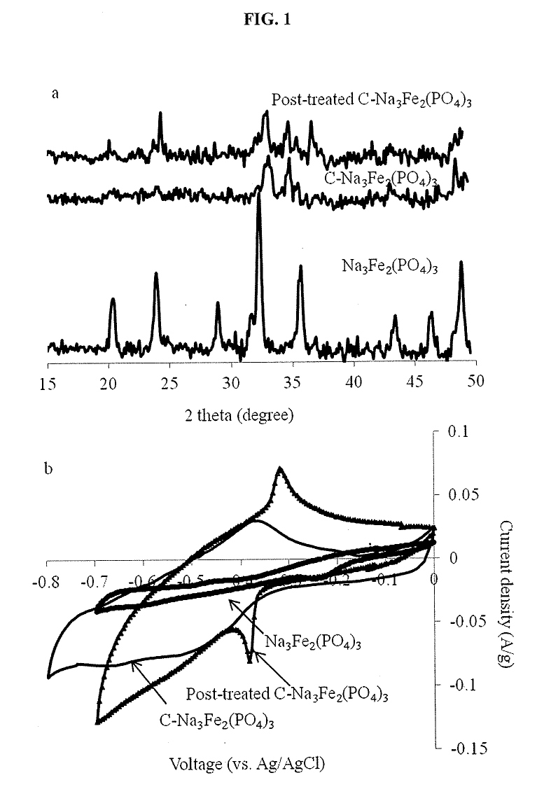

In one example, Na₃Fe₂(PO₄)₃ was prepared by mixing sodium acetate, iron nitrate, and ammonium dihydrogen phosphate together. The mixture was heated at 650° C. for 12 hours. The XRD pattern (FIG. 1) confirms that the as-made powder has a NASCION crystal structure of Na₃Fe₂(PO₄)₃. For carbon coating, about 0.44 g of the as-made Na₃Fe₂(PO₄)₃ was mixed with 0.188 g of sucrose in water. The mixture was heated at 700° C. for 4 hours in Ar to obtain carbon-coated sodium iron phosphate. After carbon coating with sucrose, the crystal structure of Na₃Fe₂(PO₄)₃ disappeared possibly because of the reduction of Fe³⁺ into Fe²⁺, which resulted in the transformation of crystal structure (FIG. 1). The Na₃Fe₂(PO₄)₃ crystal structure seemed to be partially recovered by oxidizing the carbon-coated sample in air at 300° C. for 6 hours (FIG. 1).

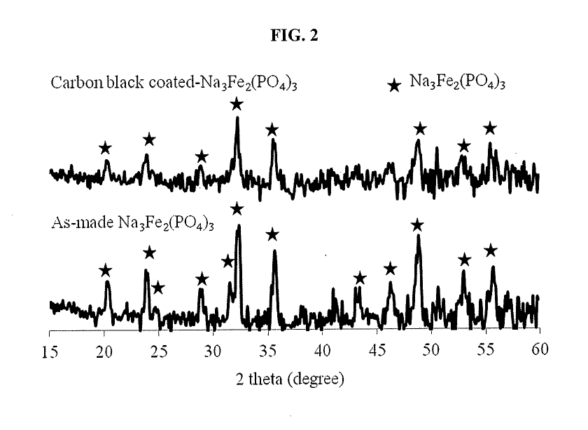

Cyclic voltammograms (CVs) of the three samples (FIG. 2) were collected from a three-electrode setup with Pt mesh as the counter electrode and Ag/AgCl as the reference electrode. The electrolyte was 1 M Na₂SO₄ aqueous solution. The scanning rate was 1 mV/s.

For the CVs, no obvious redox peaks were observed for the as-made Na₃Fe₂(PO₄)₃ even with much slower scanning rate (0.1 mV/s). The negligible electrochemical activity of the bare sodium iron phosphate in an aqueous electrolyte suggests that the application of Na₃Fe₂(PO₄)₃ as a negative electrode material may not be straightforward as in an organic electrolyte. Broad peaks were observed for the carbon-coated sample, while sharp peaks (−0.38 V and −0.32 V vs. Ag/AgCl) were observed for the air-treated or re-oxidized carbon-coated Na₃Fe₂(PO₄)₃. Average specific capacitances calculated from the CVs showed that the capacitance increased from 5 F/g to 27 F/g after carbon coating and to 36 F/g after oxidizing in air.

In another example, Na₃Fe₂(PO₄)₃ was prepared by mixing sodium acetate, iron nitrate, and ammonium dihydrogen phosphate together. The mixture was then heated at 750° C. in air for 2 days. The prepared phosphate was then mixed with 20 wt % of carbon black (BP 2000) by ball milling for 4 hours and 10 hours.

Electrodes were made by coating nickel substrates with a paste comprising 80 wt % of the phosphate, 16 wt % of acetylene black (AB), and 4 wt % of PVDF. Electrochemical tests were performed in 1 M NaNO₃ with Pt mesh as the counter electrode and Ag/AgCl as the reference electrode.

XRD patterns for the as-made and carbon black-coated Na₃Fe₂(PO₄)₃ (milled for 10 hours) are shown in FIG. 2. It shows that the crystal structure was still the same as the as-made Na₃Fe₂(PO₄)₃ after milling for 10 hours in air.

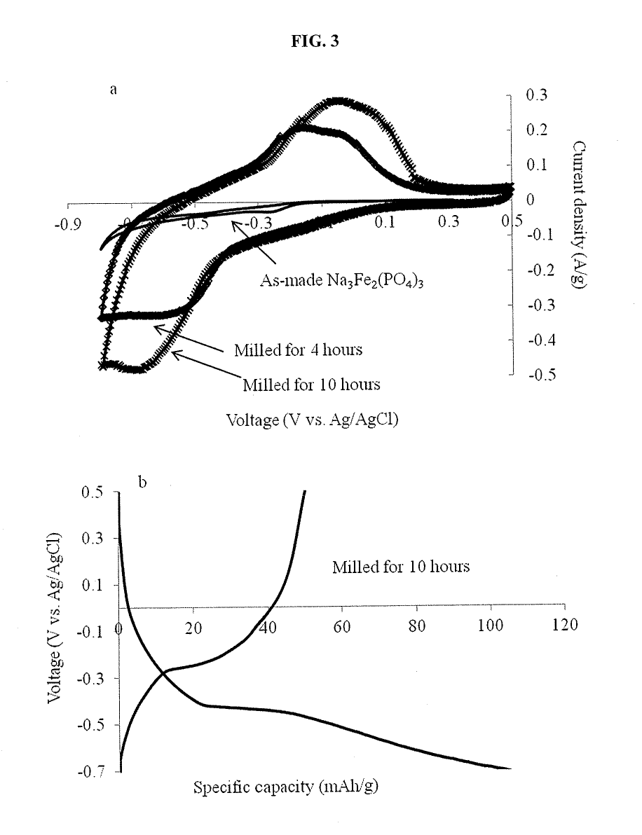

CVs for milled and as-made Na₃Fe₂(PO₄)₃ and constant current charge/discharge curves for ball milled sample are shown in FIG. 3. The as-made Na₃Fe₂(PO₄)₃ had negligible electrochemical activity, possibly because of the low electrical conductivity of the sodium iron phosphate. The sodium iron phosphate became much more active after being milled with carbon black (20 wt %, BP2000) for 4 hours (FIG. 3a). The maximum capacity came from the sample milled for 10 hours. It shows that the capacity increased with an increase in milling time, which is reasonable since the phosphate particles are expected to become smaller and the contacts between phosphate particles and carbon black particles are expected to be more intimate with an increase in milling time. For the sample milled for 10 hours, the discharge capacity can reach about 50 mAh/g at a discharge rate of 0.1 A/g (FIG. 3b).

### Example 2

### Preparation, Characterization, and Electrochemical Evaluation of Na₃Fe₃(PO₄)₄

In one synthesis, iron nitrate, sodium carbonate, and ammonium dihydrogen phosphate were mixed together in water. The mixture was then dried at 200° C. and then heated at 400° C. for about 4 hours. The powder was ground and heated at 750° C. for 3 days in air. A yellowish powder was obtained as the final product.

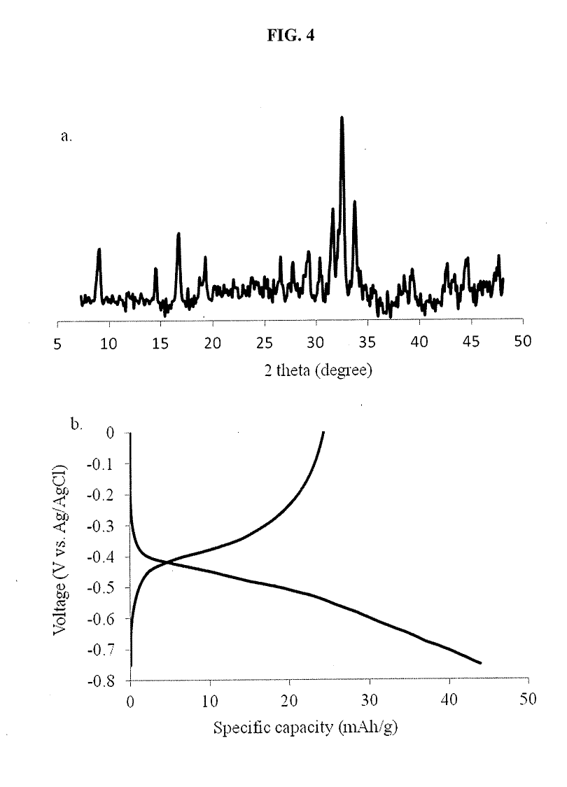

An XRD pattern of the yellowish powder is shown in FIG. 4a. Na₃Fe₃(PO₄)₄ layered structure could be identified in the XRD pattern (Lajmi et al., “Reinvestigation of the binary diagram Na₃PO₄—FePO₄ and crystal structure of a new iron phosphate Na₃Fe₃(PO₄)₄”, Materials Research Bulletin, 2002 (37), 2407). An exemplary constant current charge/discharge curve is shown in FIG. 4b. The curve was collected at 0.02 A/g in 2 M NaNO₃ aqueous solution. The specific capacity for discharge can reach 24 mAh/g even without any carbon coating. The capacity could be much higher with carbon coating. In the same electrolyte, an electrode based on iron oxide was not active suggesting Na₃Fe₃(PO₄)₄ stored the energy through a sodium ion intercalation process.

### Example 3

### Preparation, Characterization and Electrochemical Evaluation of Fe₅(PO₄)₄(OH)₃*2H₂O

In another synthesis, sodium acetate, iron nitrate, and ammonium dihydrogen phosphate were dissolved in water. The mixture was treated in a sealed autoclave at 220° C. for 24 hours. Lower temperature and shorter time can be used to make the same crystal structure. The precipitates were then collected by filtration and washed with a copious amount of water. The collected powder was finally dried at 80° C. to 120° C. for more than four hours.

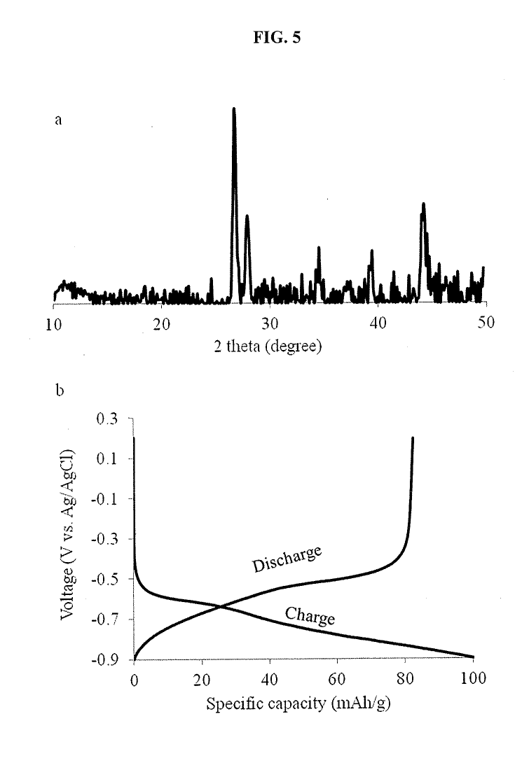

The XRD pattern for the prepared iron hydroxyl phosphate is shown in FIG. 5a. The crystal structure can be identified as Fe₅(PO₄)₄(OH)₃.2H₂O (JCPDS No. 45-1436). Constant current charge/discharge curves were collected in an aqueous solution with 1 M Na₂SO₄ and 0.1 M Na₃PO₄ (pH about 12) at 0.1 A/g charge/discharge rate. A discharge capacity of about 82 mAh/g could be obtained for the material. The sample was also tested at 1 M Na₂SO₄ solution with pH ranged from about 7 to about 10 and it was found the sample may decompose during cycling test since yellowish precipitates were observed in the solution.

Thus, the inventors demonstrated that iron phosphate-based materials including carbon-coated Na₃Fe₂(PO₄)₃, carbon-mixed Na₃Fe₂(PO₄)₃, Na₃Fe₃(PO₄)₄, and Fe₅(PO₄)₄(OH)₃.2H₂O can be used as negative electrode materials for sodium ion energy storage devices.

In summary, the inventors have disclosed the invention in several embodiments. It is to be understood that the embodiments are not mutually exclusive, and elements, materials, or steps described in connection with one embodiment may be combined with, or eliminated from, other embodiments in suitable ways to accomplish desired design objectives.

At least one embodiment includes a negative electrode material having iron phosphate-based material as the negative electrode material for sodium ion energy storage devices.

The iron phosphate-based material may include iron hydroxyl phosphate, iron sodium phosphate, iron phosphate hydrate, or ammonium iron phosphate hydrate.

The iron hydroxyl phosphate can be written as Feₓ(PO₄)_{y}(OH)_{z}.nH₂O (x: 3 to 6, y: 2 to 4, z: 1 to 6, and n: ≧0);

The iron hydroxyl phosphate may include Fe₆(PO₄)₄(OH)₅, Fe₅(PO₄)₄(OH)₃, Fe₅(PO₄)₃(OH)₅, Fe₄(PO₄)₃(OH)₃, Fe₃(PO₄)₂(OH)₂, Fe_{1.39}PO₄(OH), and their hydrates.

The sodium iron phosphate for a negative electrode material may include Na₃Fe₃(PO₄)₄, Na₃Fe₂(PO₄)₃, Na₃Fe(PO₄)₂, NaFeP₂O₇, Na₇Fe₄(P₂O₇)PO₄, NaFe₃P₃O₁₂, Na_{3.12}Fe_{2.44}(P₂O₇)₂, and Na₂Fe₃(PO₄)₃.

Na₃Fe₂(PO₄)₃ may have a crystal structure selected from α (monoclinic), β (intermediate phase), γ (triclinic poly type related to the NASCION family), or trigonal polymorph.

The iron phosphate hydrate may include FePO₄ with crystal structures of amorphous, strengite, metastrengite I, or metastrengite II.

The ammonium iron phosphate hydrate may include NH₄(Fe₂(PO₄)₂OH.H₂O).H₂O.

The iron phosphate-based material may include particles that are covered or mixed with a carbonaceous material.

The carbonaceous material may include carbon black (acetylene black, Ketjen black, Super P), graphite, graphene, activated carbon, carbon fibers, carbon nanofibers, carbon nanotubes, carbon nanoparticles, crystalline carbon, semi-crystalline carbon, amorphous carbon, or their mixtures.

The carbon coating can be formed from the decomposition of a hydrocarbon comprising organic compound, organic-inorganic compound, organo-metallic compound, or polymer.

The carbon mixing can be formed by mixing sodium iron phosphate with a carbonaceous material through a milling process.

The sodium in sodium iron phosphate may be partially replaced with potassium.

The sodium in sodium iron phosphate can be partially or fully replaced with alkaline earth metals (Mg, Ca), silver, Al, or their mixtures.

The iron phosphate-based material may include at least one metal selected from Mg, Ca, Sr, Mn, Co, Ni, Cu, Zn, Y, Ti, Zr, Nb, Mo, Al, Ga, In, Sn, Sb, Bi, or their mixtures.

The phosphate in iron phosphate can be partially replaced with silicate, borate, fluoride, aluminate, or their mixtures.

The iron phosphate-based material may have an average particle size in the range of about 1 nm to about 100 μm.

The iron phosphate-based material occupies about 50 wt % to 100 wt % in the electrochemically active layer of a negative electrode.

At least one embodiment includes a sodium ion energy storage device. The device includes a negative electrode material having iron hydroxyl phosphate, Na₃Fe₃(PO₄)₄, Na₃Fe(PO₄)₂, iron phosphate hydrates, ammonium iron phosphate hydrates, or carbon-coated/mixed sodium iron phosphate, excluding olivine crystal structure. A positive electrode material stores energy through faradic reactions or/and non-faradic reactions. The energy storage device further includes an aqueous electrolyte comprising sodium ions.

The positive electrode material may include a sodium ion intercalation material selected from Na₄Mn₉O₁₈, NaFePO₄, LiFePO₄, MnO₂, or copper hexacyanoferrate. Both NaFePO₄ and LiFePO₄ have olivine crystal structure and they have a sodium intercalation/de-intercalation potential above 3.2 V vs. Li/Li⁺, which is preferred for a positive electrode active material instead as a negative electrode material.

The positive electrode material may include a carbonaceous material that stores energy through a non-faradic ion adsorption/desorption process.

The positive electrode material may include an air catalyst that can oxidize the electrolyte and reduce oxygen during a charge/discharge cycling process.

The positive electrode material may include a conductive polymer that stores energy through faradic reactions.

The electrolyte may include a sodium salt selected but not limited to NaNO₃, NaCl, Na₂SO₄, Na₃PO₄, sodium acetate, sodium citrate, or NaOH.

The electrolyte may include a potassium or lithium salt selected from potassium nitrate, potassium chloride, potassium sulfate, potassium phosphate, potassium acetate, potassium citrate, potassium carbonate, potassium hydroxide, lithium nitrate, lithium sulfate, lithium chloride, lithium acetate, lithium citrate, lithium carbonate, lithium hydroxide.

The electrolyte may have a pH in the range of about 1 to about 13.

Thus, while only certain embodiments have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. A negative electrode material for an aqueous sodium ion based energy storage device, comprising at least one phosphate selected from iron hydroxyl phosphate, Na₃Fe₃(PO₄)₄, Na₃Fe(PO₄)₂, iron phosphate hydrate, or ammonium iron phosphate hydrate.

2. The negative electrode material of claim 1, wherein said iron hydroxyl phosphate is a compound represented by the general formula: Feₓ(PO₄)_{y}(OH)_{z}.nH₂O (x: 3 to 6, y: 2 to 4, z: 1 to 6, and n: ≧0).

3. The negative electrode material of claim 1, wherein said iron hydroxyl phosphate comprises: Fe₆(PO₄)₄(OH)₅, Fe₅(PO₄)₄(OH)₃, Fe₅(PO₄)₃(OH)₅, Fe₄(PO₄)₃(OH)₃, Fe₃(PO₄)₂(OH)₂, Fe_{1.39}PO₄(OH), or hydrates thereof.

4. The negative electrode material of claim 1, wherein said iron phosphate hydrate comprises FePO₄ with a crystal structure of amorphous, strengite, metastrengite I, or metastrengite II.

5. The negative electrode material of claim 1, wherein said at least one ammonium iron phosphate hydrate comprises NH₄(Fe₂(PO₄)₂OH.H₂O).H₂O.

6. The negative electrode material of claim 1, wherein said at least one phosphate has an average particle size in the range from about 1 nm to about 100 μm.

7. The negative electrode material of claim 1, wherein said at least one phosphate comprises at least one metal selected from Li, K, Mg, Ca, Sr, Mn, Co, Ni, Cu, Zn, Y, Ti, Zr, Nb, Mo, Al, Ga, In, Sn, Sb, or Bi.

8. The negative electrode material of claim 1, wherein said at least one phosphate comprises particles that are covered or mixed with a carbonaceous material comprising: carbon black (acetylene black, Ketjen black, Super P), graphite, graphene, activated carbon, carbon fibers, carbon nanofibers, carbon nanotubes, carbon nanoparticles, crystalline carbon, semi-crystalline carbon, amorphous carbon, or mixtures thereof.

9. The negative electrode material of claim 1, wherein said at least one phosphate occupies about 50 wt % to 90 wt % in the electrochemically active layer in the negative electrode.

10. The negative electrode material of claim 8, wherein said at least one phosphate occupies about 50 wt % to 90 wt % in the electrochemically active layer in the negative electrode.

11. A negative electrode material of non-olivine crystal structure for an aqueous sodium ion energy storage device, comprising one of a carbon-coated sodium iron phosphate, a carbon-mixed sodium iron phosphate, or mixtures thereof.

12. The negative electrode material of claim 11, wherein the carbon in said carbon-coated phosphate is formed from the decomposition of a hydrocarbon comprising organic compound, organic-inorganic compound, organo-metallic compound, polymer, or mixtures thereof.

13. The negative electrode material of claim 11, wherein the carbon in said carbon-mixed phosphate is formed by mixing sodium iron phosphate with carbonaceous material through a high energy milling process.

14. The negative electrode material of claim 11, wherein said sodium iron phosphate comprises Na₃Fe₃(PO₄)₄, Na₂Fe(PO₄)₂, NaFeP₂O₇, Na₇Fe₄(P₂O₇)PO₄, NaFe₃P₃O₁₂, Na_{3.12}Fe_{2.44}(P₂O₇)₂, Na₂Fe₃(PO₄)₃, NaFe₂Al(PO₄)₃, or mixtures thereof.

15. The negative electrode material in claim 11, wherein said sodium iron phosphate comprises Na₃Fe₂(PO₄)₃.

16. The negative electrode material of claim 15, wherein said Na₃Fe₂(PO₄)₃ has a crystal structure similar to NASCION.

17. The negative electrode material of claim 15, wherein said Na₃Fe₂(PO₄)₃ has a crystal structure selected from α (monoclinic), β (intermediate phase), or trigonal polymorph.

18. An energy storage device, comprising:
A negative electrode material of non-olivine crystal structure comprising at least one phosphate selected from iron hydroxyl phosphate, Na₃Fe₃(PO₄)₄, Na₃Fe(PO₄)₂, iron phosphate hydrate, ammonium iron phosphate hydrate, carbon-coated sodium iron phosphate, carbon-mixed sodium iron phosphate, or mixtures thereof;
a positive electrode material to store energy through faradic reactions or/and non-faradic reactions; and
an aqueous electrolyte comprising sodium ions.

19. The energy storage device of claim 18, wherein said positive electrode material comprises a sodium ion intercalation material selected from Na₄Mn₉O₁₈, NaFePO₄, MnO₂, copper hexacyanoferrate, or mixtures thereof.

20. The energy storage device of claim 18, wherein said positive electrode material comprises a carbonaceous material that stores energy through a non-faradic ion adsorption/desorption process.

21. The energy storage device of claim 18, wherein said positive electrode material comprises an air catalyst that can oxidize the electrolyte and reduce oxygen during a charge/discharge cycling process.

22. The energy storage device of claim 18, wherein said positive electrode material comprises a conductive polymer that stores energy through faradic reactions.

23. The energy storage device of claim 18, wherein said electrolyte comprises a sodium salt selected from sodium nitrate, sodium chloride, sodium sulfate, sodium phosphate, sodium acetate, sodium citrate, sodium hydroxide, or mixtures thereof.

24. The energy storage device of claim 18, wherein said electrolyte comprises a potassium or lithium salt selected from potassium nitrate, potassium chloride, potassium sulfate, potassium phosphate, potassium acetate, potassium citrate, potassium carbonate, potassium hydroxide, lithium nitrate, lithium sulfate, lithium chloride, lithium acetate, lithium citrate, lithium carbonate, lithium hydroxide, or mixtures thereof.

25. The energy storage device of claim 18, wherein said electrolyte has a pH in the range from about 1 to about 13.
